(19) United States
(12) Patent Application Publication
(10) Pub. No.: US 2006/0256051 A1
(43) Pub. Date: Nov. 16, 2006

(54) Display apparatus, method of driving the same and apparatus for driving the same

(76) Inventors: Chang-Hun Lee, Yongin-si (KR); Hak-Sun Chang, Yongin-si (KR); Jun-Woo Lee, Anyang-si (KR)

Correspondence Address: CANTOR COLBURN, LLP, 55 GRIFFIN ROAD SOUTH, BLOOMFIELD, CT, 06002, US

(21) Appl. No.: 11/407,630

(22) Filed: Apr. 20, 2006

(30) Foreign Application Priority Data
May 10, 2005 (KR) 2005-38746

(51) Int. Cl. G09G 3/36

(52) U.S. Cl. 345/87

(57) ABSTRACT

A display apparatus includes a display panel having a liquid crystal layer operated at an optically compensated birefringence (“OCB”) mode to display an image. A driving system receives preliminary data and applies first and second gamma curves to the preliminary data so as to output first and second gray-scale voltages, respectively, to the at least one of the first and the second substrate. The first and second gray-scale voltages depend on the first and second gamma curves. A white gray-scale voltage of the first gamma curve is smaller than a minimum voltage to maintain a bend aligned state of the liquid crystal layer, and the white gray-scale voltage of the second gamma curve is larger than the minimum voltage. Therefore, a visibility and a brightness of an image are improved while a bend-aligned state of the liquid crystal layer is maintained.

This application claims priority to Korean Patent Application No. 2005-38746, filed on May 10, 2005 and all the benefits accruing therefrom under 35 U.S.C. §119, and the contents of which in its entirety are herein incorporated by reference.

### BACKGROUND OF THE INVENTION

1. Field of the Invention

The present invention relates to a display apparatus, a method of driving the display apparatus, and an apparatus for driving the display apparatus. More particularly, the present invention relates to a display apparatus for displaying an image with an improved visibility and an enhanced brightness, a method of driving the display apparatus, and an apparatus for driving the display apparatus.

2. Description of the Related Art

Recently, an optically compensated birefringence (“OCB”) mode has been widely employed for a liquid crystal display (“LCD”) apparatus to increase a viewing angle and a response speed. The OCB mode corresponds to a process for driving liquid crystal molecules in the LCD apparatus after the liquid crystal molecules are bend-aligned. Particularly, after the liquid crystal molecules are homogenously aligned at an initial state, the liquid crystal molecules sequentially conform a transient splay state, an asymmetric splay state, and a bend-aligned state when a predetermined voltage is applied to the liquid crystal molecules, and then the liquid crystal molecules are driven at the OCB mode.

Therefore, the LCD apparatus requires time to acquire the bend-alignment of the liquid crystal molecules. After the liquid crystal molecules are bend-aligned, then the LCD apparatus has an improved response speed and an enhanced viewing angle.

However, the bend-alignment state is maintained during an operation of the LCD apparatus. A quality of an image displayed by the LCD apparatus may be deteriorated when the bend-aligned state is failed during the operation of the LCD apparatus.

### BRIEF SUMMARY OF THE INVENTION

To settle the above-mentioned problem, the present invention provides a display apparatus for displaying an image with an improved visibility and an enhanced brightness.

The present invention also provides an apparatus for driving the above display apparatus.

The present invention still also provides a method of driving the above display apparatus.

In accordance with exemplary embodiments of the present invention, a display apparatus includes a first substrate, a second substrate, a liquid crystal layer, and a driving system. The first substrate includes a first electrode. The second substrate opposes the first substrate. The second substrate includes a second electrode. The liquid crystal layer is disposed between the first and second substrates. The liquid crystal layer includes liquid crystal molecules that are horizontally oriented in one direction. The liquid crystal molecules are aligned symmetrically bent with respect to an imaginary center plane between the first and second substrates when an electric field is generated between the first and second electrodes. The driving system outputs a first gray-scale voltage and a second gray-scale voltage into at least one of the first and the second substrate after the driving system receives preliminary data from an exterior source and converts the preliminary data into the first and the second gray-scale voltages by applying a first gamma curve and a second gamma curve, and the first and the second gray-scale voltages depend on the first and second gamma curves, respectively.

A white gray-scale voltage of the second gamma curve is a minimum voltage to maintain a bend-aligned state of the liquid crystal layer when the first gamma curve is a standard gamma curve.

Preferably, the white gray-scale voltage of the first gamma curve is smaller than a minimum voltage to maintain a bend-aligned state of the liquid crystal layer, and the white gray-scale voltage of the second gamma curve is larger than the minimum voltage to maintain a bend-aligned state of the liquid crystal layer.

More preferably, a sum of transmittances of the first gamma curve and the second gamma curve corresponds to a transmittance of a standard gamma curve.

The driving system includes a first storing section, a second storing section, and a timing controlling section. The first storing section stores the preliminary data based on a first driving frequency. The second storing section stores first and second reference gray-scale data corresponding to the first and second gamma curves, respectively. The timing controlling section reads out the preliminary data stored in the first storing section based on a second driving frequency having a multiple frequency of the first driving frequency, and reads out the first and second reference gray-scale data stored in the second storing section based on the second driving frequency.

The driving system may further include a reference gray-scale voltage generating section generating first and second reference gray-scale voltages based on the first and second reference g ray-scale data, respectively, and a data driving section converting the preliminary data into first and second analog gray-scale voltages based on the first and second reference gray-scale voltages, respectively, to output the first and second gray-scale voltages to the display panel.

The driving system may further include a driving voltage generating section providing reference voltages to the reference gray-scale voltage generating section.

Alternatively, the driving system may include a first storing section, a second storing section and a timing controlling section. The first storing section stores the preliminary data based on a first driving frequency. The second storing section stores first and second reference gray-scale data corresponding to the first and second gamma curves, respectively. The timing controlling section reads out the preliminary data stored in the first storing section based on a second driving frequency having a multiple frequency of the first driving frequency, and applies the first and second gamma curves to the preliminary data to output first and second gray-scale data.

In such an embodiment, the timing controlling section includes an interpolating part and a table part. The interpolating part generates the first and second gray-scale data corresponding to entire gray-scale levels based on first and second reference gray-scale data. The table part outputs first and second gray-scale data corresponding to each of the preliminary data.

The driving system may further include a data driving section outputting first and second gray-scale voltages to the display panel based on the first and second gray-scale data, respectively.

The driving system may output the first gray-scale voltage for a first time period of a frame image, and subsequently output the second gray-scale voltage for a second time period of the frame image, where the frame image during the first time period is brighter than the frame image during the second time period.

The first gamma curve may have a higher brightness than the second gamma curve.

In accordance with another aspect of the present invention, a driving apparatus of a display apparatus including a liquid crystal layer operated at an OCB mode to display an image, includes a timing controlling section, a storing section, a reference gray-scale voltage generating section, and a data driving section.

The timing controlling section receives preliminary data based on a first driving frequency to output the preliminary data based on a second driving frequency. The storing section stores first and second reference gray-scale data corresponding to first and second gamma curves, respectively. The first gamma curve has a white gray-scale voltage smaller than a minimum voltage to maintain a bend-aligned state of the liquid crystal layer and the second gamma curve has the white gray-scale voltage larger than the minimum voltage. The reference gray-scale voltage generating section generates first and second reference gray-scale voltages based on the first and second reference gray-scale data. The data driving section converts the preliminary data into first and second gray-scale voltages based on the first and second reference gray-scale voltages, respectively. The data driving section outputs the first and second gray-scale voltages to the display panel.

Preferably, a sum of transmittances of the first gamma curve and the second gamma curve corresponds to a transmittance of a standard gamma curve. Also, the data driving section outputs the first and second gray-scale voltages to the display panel in one frame.

In accordance with still other exemplary embodiments of the present invention, a driving apparatus for a display apparatus including a liquid crystal layer operated at an OCB mode to display an image, includes a storing section, a timing controlling section and a data driving section. The storing section stores first and second reference gray-scale data corresponding to first and second gamma curves, respectively. The first gamma curve has a white gray-scale voltage smaller than a minimum voltage to maintain a bend-aligned state of the liquid crystal layer and the second gamma curve has a white gray-scale voltage larger than the minimum voltage. The timing controlling section receives preliminary data and applies the first and second gamma curves to the preliminary data, respectively, to convert the preliminary data into first and second gray-scale data and output the first and second gray-scale data. The data driving section converts the first and second gray-scale data into first and second analog gray-scale voltages to output the first and second gray-scale voltages to a display panel.

In order to drive a display apparatus including a liquid crystal layer operated at an OCB mode to display an image in accordance with still other exemplary embodiments of the present invention, a first gamma curve is applied to preliminary frame data in a first time period of the frame to generate a first gray-scale voltage. A second gamma curve having a lower brightness than the first gamma curve is applied to the preliminary frame data for a second time period of the frame to generate a second gray-scale voltage.

The first time period may occur prior to the second time period.

The method further includes outputting the first gray-scale voltage and the second gray-scale voltage to data lines of the display apparatus.

Preferably, the first time is substantially identical to the second time, or the first time is substantially different with the second time.

According to the above, since the first and second gamma curves of which white gray-scale voltage has a minimum voltage to maintain a bend-aligned state of the liquid crystal layer is applied to frame data, first and second sub frames may be displayed in one frame, to thereby improve a visibility and a brightness of an image.

### BRIEF DESCRIPTION OF THE DRAWINGS

The above and other advantages of the present invention will become readily apparent by reference to the following detailed description when considered in conjunction with the accompanying drawings wherein:

FIG. 1 is a block diagram illustrating an exemplary embodiment of a display apparatus in accordance with the present invention;

FIG. 2 is a plan view illustrating an exemplary embodiment of a display panel driven at an OCB mode in accordance with the present invention;

FIG. 3 is a cross-sectional view illustrating the exemplary display panel taken along line I-I′ in FIG. 2;

FIG. 4 is a graph illustrating a relationship between a voltage and a transmittance at an OCB mode of an exemplary embodiment of a display panel in accordance with the present invention;

FIGS. 5A to 5C are graphs illustrating first and second gamma curves in accordance with exemplary embodiments of the present invention;

FIG. 6 is a block diagram illustrating an exemplary timing controlling section of the exemplary display apparatus in FIG. 1;

FIG. 7 is a block diagram illustrating another exemplary timing controlling section of the exemplary display apparatus in accordance with the present invention;

FIG. 8 is a block diagram illustrating an exemplary data driving section in FIG. 1;

FIG. 9 is a block diagram illustrating an exemplary data driving chip of the exemplary data driving section in FIG. 8;

FIG. 10 is a block diagram illustrating another exemplary embodiment of a display apparatus in accordance with the present invention;

FIG. 11 is a block diagram illustrating an exemplary timing controlling section of the exemplary display apparatus in FIG. 10;

FIG. 12 is a block diagram illustrating an exemplary data driving section in FIG. 10;

FIG. 13 is a block diagram illustrating an exemplary first data driving chip of the exemplary data driving section of FIG. 12;

FIG. 14 is a flow chart illustrating an exemplary method of driving an exemplary embodiment of a display apparatus in accordance with the present invention; and

FIG. 15 is a diagram illustrating an exemplary process for driving the exemplary display apparatus in accordance with the exemplary method in FIG. 14.

### DETAILED DESCRIPTION OF THE INVENTION

The invention will now be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will be described in detail with reference to the accompanying drawings.

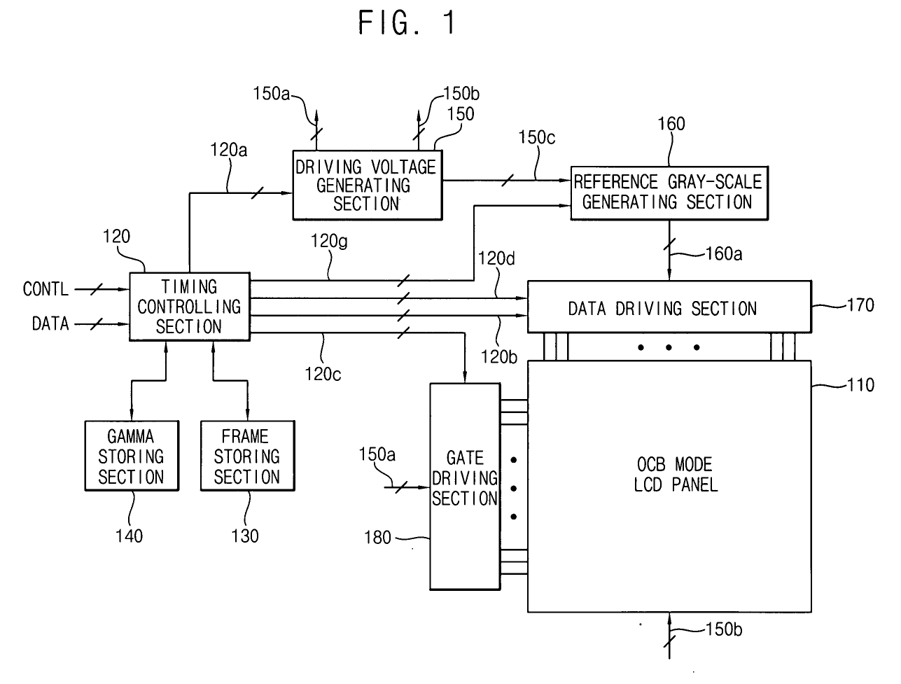

FIG. 1 is a block diagram illustrating an exemplary embodiment of a display apparatus in accordance with the present invention.

Referring to FIG. 1, the display apparatus includes a display panel 110, a timing controlling section 120, a frame storing section 130, a gamma storing section 140, a driving voltage generating section 150, a gray-scale reference voltage generating section 160, a data driving section 170, and a gate driving section 180.

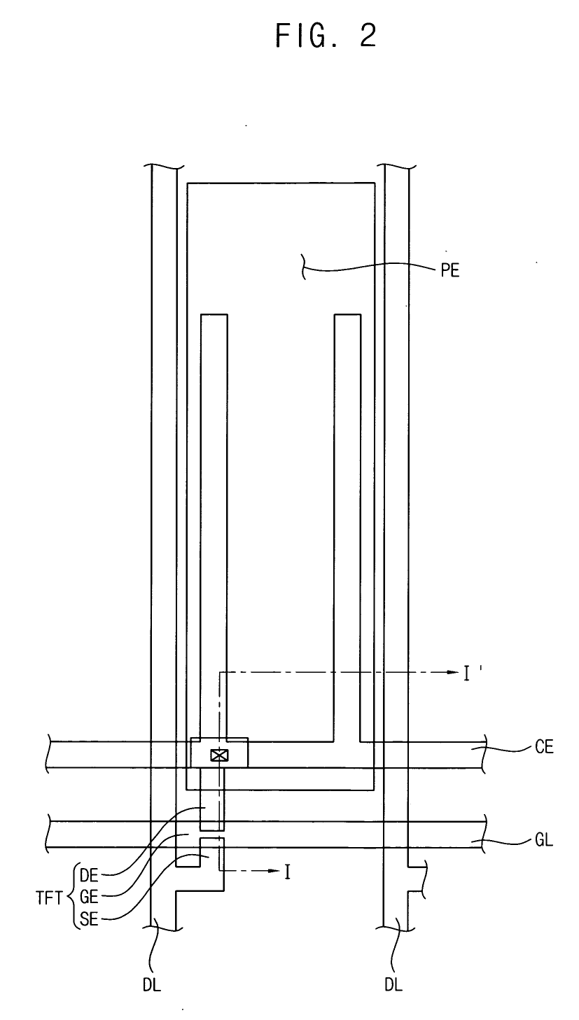

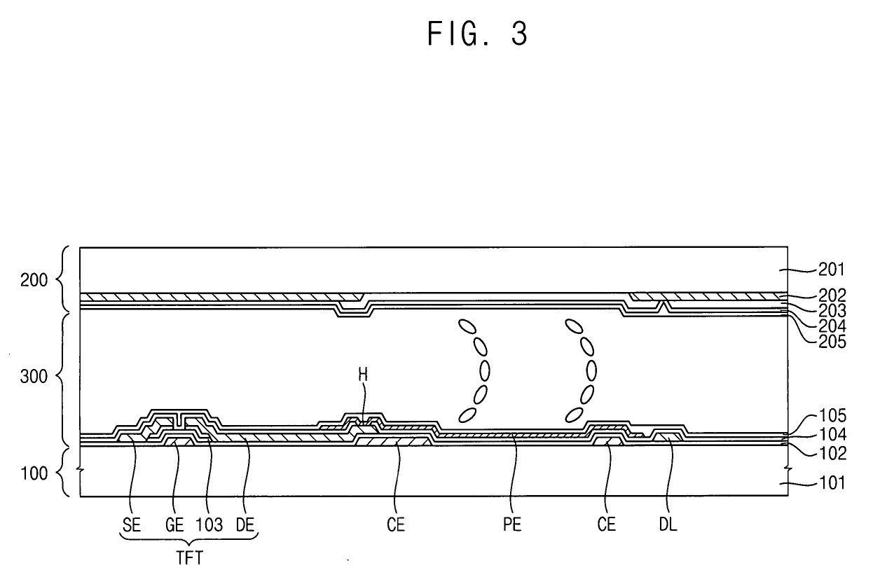

FIG. 2 is a plan view illustrating an exemplary embodiment of a display panel operated at an OCB mode in accordance with the present invention. FIG. 3 is a cross-sectional view illustrating the exemplary display panel taken along line I-I′ in FIG. 2.

Referring to FIGS. 2 and 3, a display panel 110 includes an array substrate 100, a color filter substrate 200, and a liquid crystal layer 300.

The array substrate 100 includes a first base substrate 101, that may include a transparent insulating substrate such as glass or plastic. A plurality of data lines DL and a plurality of gate lines GL are formed on the first base substrate 101. The data lines DL and the gate lines GL are crossed with respect to each other. For example, a plurality of gate lines GL may extend substantially parallel with respect to each other in a first direction in one layer of the array substrate 100, and the plurality of data lines DL may extend substantially parallel with respect to each other in a second direction in another layer of the array substrate 100, where the second direction is substantially perpendicular to the first direction. Pixel areas are defined by the data lines DL and the gate lines GL. For example, each pixel area is defined by a pair of adjacent data lines DL and a pair of adjacent gate lines GL. A pixel ‘P’ is formed at each pixel area and includes a switching element such as a thin film transistor (“TFT”), a pixel electrode (“PE”), and a storage capacitor CST.

The switching element TFT includes a gate electrode GE electrically connected to the gate line GL, a source electrode SE electrically connected to the data line DL, and a drain electrode DE electrically connected to the pixel electrode PE. A gate insulating layer 102 and a channel layer 103 are formed between the gate electrode GE and the source and drain electrodes SE and DE. The gate insulating layer 102 insulates the gate lines GL from the data lines DL.

The pixel electrode PE is electrically connected to the drain electrode DE through a contact hole ‘H’ formed by partially removing a passivation layer 104 formed on the drain electrode DE.

The storage capacitor CST is defined by a storage common line CE and the pixel electrode PE. The storage common line CE includes substantially the same metal layer as the gate electrode GE and the gate line GL. That is, the storage common line CE may be formed during the same manufacturing process as forming the gate electrode GE and the gate line GL. A first alignment layer 105 with a first rubbing direction ‘R’ is formed on the first base substrate 101 on which the pixel electrode PE is formed.

The color filter substrate 200 includes a second base substrate 201 and a light blocking pattern 202 on the second base substrate 201. The light blocking pattern 202 defines areas corresponding to the pixels ‘P’, and blocks a leaked light. Color filter patterns 203 such as a red color filter pattern, a green color filter pattern and a blue color filter pattern are formed on the above areas corresponding to the pixels ‘P’. Although particular color filter patterns are described, other color filter patterns would be within the scope of these embodiments. A common electrode 204 is formed on the color filter patterns 203, and the common electrode 204 is opposite to the pixel electrodes PE.

A second alignment layer 205 with a same rubbing direction as the first alignment layer 105 is formed on the common electrode 204. With the first and second alignment layers 105 and 205 being rubbed in parallel with each other, a splay alignment state is achieved where the liquid crystal molecules within the liquid crystal layer 300 are laid down.

The liquid crystal layer 300 is aligned to be operated at an optical compensated birefringency (“OCB”) mode, also known as an optically compensated bend mode. The liquid crystal layer 300 includes nematic liquid crystals. The nematic liquid crystals are splay-aligned, as achieved by the first and second alignment layers 105 and 205, and then are bend-aligned when a predetermined voltage is applied to the liquid crystal layer 300. In the bend-alignment stage of the liquid crystal molecules, the liquid crystal molecules are aligned symmetrically bent with respect to an imaginary center plane between the array substrate 100 and the color filter substrate 200, as shown in FIG. 3. After the liquid crystals are bend-aligned, a predetermined data voltage is applied to the liquid crystal layer so as to change a light transmittance to display an image. For example, when the display panel is operated at a normally white mode, the bend-aligned state corresponds to a white mode.

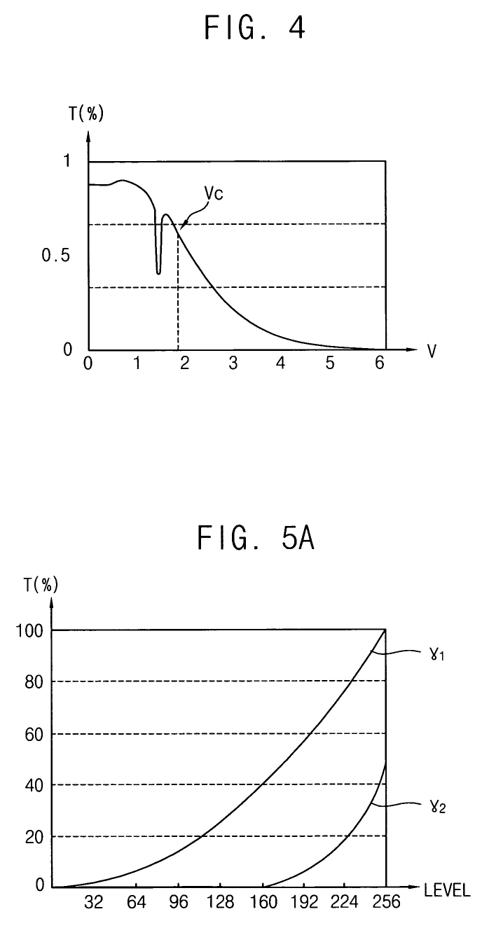

FIG. 4 is a graph illustrating a relationship between a voltage and a transmittance at an OCB mode of an exemplary embodiment of a display panel in accordance with the present invention.

Referring to FIG. 4, the bend-aligned state is failed when a voltage applied to the liquid crystal layer 300 exceeds a critical voltage (Vc). Therefore, a voltage exceeding the critical voltage (Vc) is required to drive the display panel at the OCB mode with a white gray-scale level. As shown in FIG. 4, when the display panel at the OCB mode has about 2V of the white gray-scale level and about 6V of a black gray-scale level, the display panel at the OCB mode may have about sixty four gray-scales, about two hundreds fifty six gray-scales, about one thousand twenty four gray-scales, etc. That is, gray-scale voltages applied to the display panel substantially are in a range of about 2V to about 6V. Accordingly, since a minimum voltage (a white gray-scale voltage) exceeds the critical voltage (Vc), liquid crystal molecules in the liquid crystal layer 300 may be maintained at the bend-aligned state.

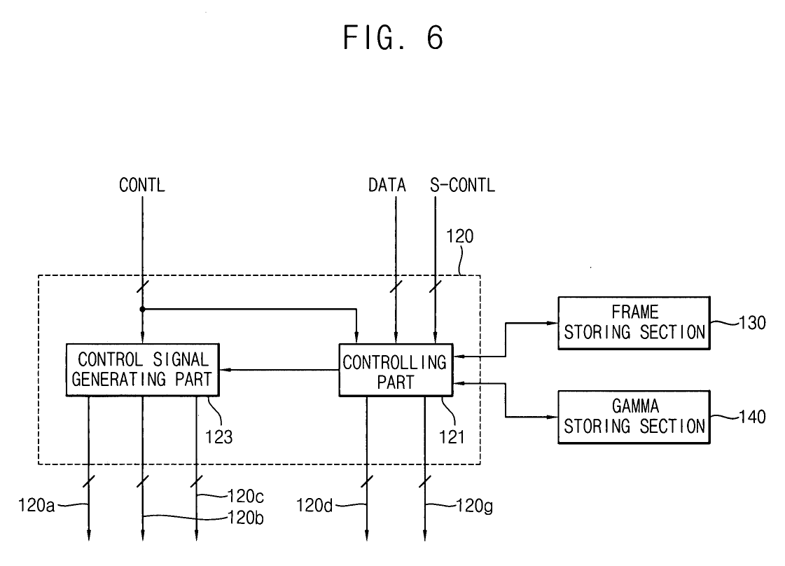

Referring again to FIG. 1, the timing controlling section 120 generates a first control signal 120a, a second control signal 120b, and a third control signal 120c based on a control signal CONTL that corresponds to a first driving frequency from an external apparatus to control the display apparatus. The first to third control signals 120a, 120b, and 120c correspond to a second driving frequency. The control signal CONTL includes a gamma selection signal S-CONTL, as shown in FIG. 6, transmitted from a user interface, for example, a remote controller.

The first control signal 120a is provided to the driving voltage generating section 150, the second control signal 120b is provided to the data driving section 170, and the third control signal 120c is provided to the gate driving section 180 to control each respective section.

The timing controlling section 120 also provides the data driving section 170 with a preliminary data 120d inputted from an external apparatus.

The timing controlling section 120 readouts first and second gray-scale reference data 120g corresponding to first and second gamma curves stored in the gamma storing section 140, respectively, and provides the first and second gray-scale reference data 120g to the gray-scale reference voltage generating section 160. For example, the timing controlling section 120 may readout predetermined first and second gray-scale reference data 120g corresponding to first and second gamma curves (γ1) and (γ2) stored in gamma storing section 140, or the timing controlling section 120 may readout the first and second gray-scale reference data 120g corresponding to the first and second gamma curves (γ1) and (γ2) selected by the user.

The frame storing section 130 stores the preliminary data DATA inputted from the external apparatus by the frame. The timing controlling section 120 stores the preliminary data DATA based on the first driving frequency into the frame storing section 130, and synchronizes the preliminary data DATA with the second driving frequency to readout the stored preliminary data DATA 120d.

The second driving frequency is m (m denotes a positive integer) times the first driving frequency.

For example, when the first driving frequency is about 60 Hz, m is two, and the second driving frequency is about 120 Hz, N-th (N denotes a positive integer) preliminary data corresponding to the first driving frequency is converted into first and second gray-scale voltages by the second driving frequency. The first and second gray-scale voltages are outputted from the frame storing section 130 to a display panel 110 through the data driving section 170 in one frame based on the first driving frequency.

The gamma storing section 140 includes a read-only memory (“ROM”), and stores about ten to about twenty sampled reference gray-scale data sampled by corresponding to a plurality of the gamma curves. For example, the gamma storing section 140 stores the sampled reference gray-scale data corresponding to a first gamma curve (γ1) and the sampled reference gray-scale data corresponding to a second gamma curve (γ2).

A pair of predetermined gamma curves of the first and second gamma curves (γ1, γ2) may be stored at the gamma storing section 140 to be applied to first and second reference gray-scale data, or a plurality of pairs of the first and second gamma curves (γ1,γ2) may be stored at the gamma storing section 140 to be variously applied to the first and second reference gray-scale data according to gamma selecting signals selected by the user.

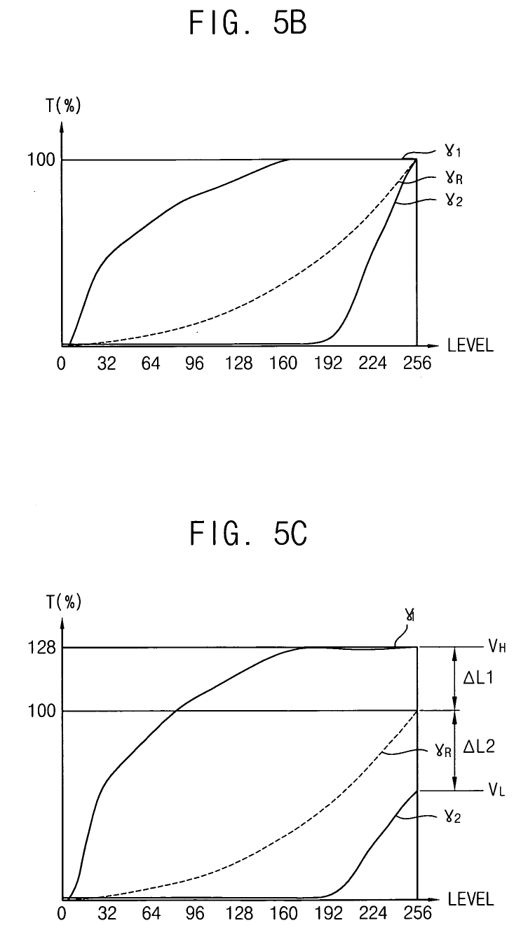

FIGS. 5A to 5C are graphs illustrating exemplary embodiments of first and second gamma curves in accordance with the present invention. The first gamma curve is a data gamma curve applied to a normal image data, and the second gamma curve is an impulsive gamma curve so as to generate an impulsive gamma wave. The second gamma curve has a lower brightness than the first gamma curve.

Referring to FIG. 5A, the first gamma curve (γ1) is a reference gamma curve, and the second gamma curve (γ2) has a relatively low brightness to generate an impulsive wave. The reference gamma curve is a general gamma curve applied to a display apparatus. For example, the reference gamma curve has a gamma value (γ) of about 2.4. The gamma value (γ) represents a numerical parameter describing the non-linear relationship between pixel value and luminance.

As shown in FIG. 5A, the second gamma curve (γ2) has a gray-scale voltage of black (e.g., about 6V) at a brightness level of about zero to about one hundred sixty. The second gamma curve (γ2) has a gray-scale voltage including a transmittance augmented in accordance with an increase of the first gamma curve (γ1) at a brightness level of about one hundred sixty to about two hundred fifty five.

A white gray-scale voltage of the first gamma curve (γ1) is less than the critical voltage (Vc) (e.g., about 0V), and a white gray-scale voltage of the second gamma curve (γ2) exceeds the critical voltage (Vc).

Referring to FIGS. 5B and 5C, the first gamma curve (γ1) is a gamma curve having a relatively high brightness, and the second gamma curve (γ2) is a gamma curve having a relatively low brightness. A sum of the first and second gamma curves (γ1) and (γ2) corresponds to a reference gamma curve (γR).

Therefore, a sum of transmittances of the first and second gamma curves (γ1, γ2) is substantially identical to a transmittance of the reference gamma curve (γR) at any gray-scale levels. Accordingly, any first and second gamma curves (γ1, γ2) of which the sum is substantially identical to the reference gamma curve (γR) may be used, and thus the examples shown in FIGS. 5B and 5C are illustrative only and should not be construed as limiting the present invention.

A voltage less than the critical voltage (Vc) may be employed for the white gray-scale voltage of the first gamma curve (γ1), and a voltage exceeding the critical voltage (Vc) may be employed for the white gray-scale voltage of the second gamma curve (γ2).

Referring to FIG. 5B, the first gamma curve (γ1) has gray-scale voltages with a transmittance increasing from about 0% to about 100% when a brightness level increases from about zero to about one hundred seventy. The first gamma curve (γ1) has gray-scale voltages with a transmittance of about 100% when the brightness level exceeds one hundred seventy.

The second gamma curve (γ2) has a distribution of the gray-scale voltages, which is contrary to a distribution of the gray-scale voltages of the first gamma curve (γ1). The second gamma curve (γ2) has the gray-scale voltages with a transmittance of about 0% at the brightness level of about zero to about one hundred seventy. The second gamma curve (γ2) has the gray-scale voltages in a range from a gray-scale voltage with a transmittance of about 0% to a gray-scale voltage exceeding the critical voltage (Vc). Accordingly, the white gray-scale voltage of the first gamma curve (γ1) has a voltage about 0V less than the critical voltage (Vc), and the white gray-scale voltage of the second gamma curve (γ2) has a voltage exceeding the critical voltage (Vc).

Referring to FIG. 5C, the first gamma curve (γ1) has gray-scale voltages with a transmittance increasing from about 0% to about 128% when the brightness level increases from about zero to about one hundred seventy. The first gamma curve (γ1) has gray-scale voltages with a transmittance of about 128% when the brightness level exceeds one hundred seventy. Therefore, the first gamma curve (γ1) has the gray-scale voltage that is less than the critical voltage (Vc).

The second gamma curve (γ2) has a distribution of the gray-scale voltages, which is contrary to a distribution of the gray-scale voltages of the first gamma curve (γ1). Particularly, the second gamma curve (γ2) has the gray-scale voltages with a transmittance of about 0% at the brightness level of about zero to about one hundred seventy. The second gamma curve (γ2) has the gray-scale voltages increasing from a gray-scale voltage with a transmittance of about 0% to about 70% when the brightness level exceeds one hundred seventy.

Accordingly, as further shown in FIG. 5C, the white gray-scale voltage (V_{H}) of the first gamma curve (γ1) has a voltage about 0 V less than the critical voltage (Vc), and the white gray-scale voltage (V_{L}) of the second gamma curve (γ2) has a voltage exceeding the critical voltage (Vc).

A difference value between the white gray-scale voltage (V_{H}) of the first gamma curve (γ1) and the white gray-scale voltage (V_{L}) of the second gamma curve (γ2) is controlled by a ratio (duty ratio) between a first time and a second time. An image data to which the first gamma curve is applied is displayed in the first time and an image data to which the second gamma curve is applied is displayed in the second time. The first time and a second time may correspond to a first frame image and a second frame image of one frame. The first time and the second time may be the same, or, alternatively, the first time may be different from the second time.

When the ratio between the first time and the second time is about 1:1, a first distance (ΔL1) is substantially same as a second distance (ΔL2). Alternatively, when the ratio between the first time and the second time is not 1:1, then the first and second distances (ΔL1) and (ΔL2) are different. The first distance (ΔL1) is a distance between a point where the transmittance is about 100% at two hundred fifty six gray-scale level and a point of the first gamma curve (γ1) at two hundred fifty six gray-scale level. The point of the first gamma curve (γ1) at two hundred fifty six gray-scale level corresponds to the white gray-scale voltage (V_{H}) of the first gamma curve (γ1). The second distance (ΔL2) is a distance between the point where the transmittance is about 100% at two hundred fifty six gray-scale level, that is the same point used for measuring the first distance (ΔL1), and a point of the second gamma curve (γ2) at two hundred fifty six gray-scale level. The point of the second gamma curve (γ2) at two hundred fifty six gray-scale level corresponds to the white gray-scale voltage (V_{L}) of the second gamma curve (γ2).

Referring to FIGS. 5B and 5C, the first gamma curve (γ1) has the white gray-scale voltage, e.g. V_{H}, less than the critical voltage (Vc), and the second gamma curve (γ2) has the white gray-scale voltage, e.g. V_{L}, exceeding the critical voltage (Vc). The white gray-scale voltage at an impulsive state is less than the critical voltage (Vc).

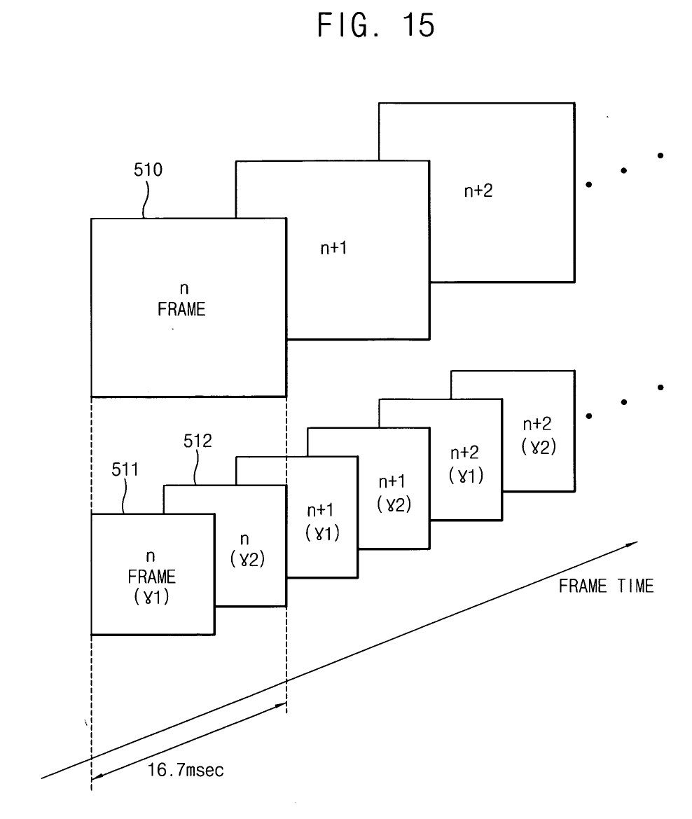

The display panel 110 displays first and second sub-frames respectively corresponding to the first and second gamma curves (γ1) and (γ2) based on an image data of an N-th frame, as will be further described below with respect to FIG. 15, so that a visibility and a light-transmittance of an image may increase while the bend-aligned state is maintained.

With further reference to FIG. 1, the driving voltage generating section 150 generates driving voltages to drive the display apparatus after receiving the first control signal 120a from the timing controlling section 120. Particularly, the driving voltage generating section 150 provides gate voltages 150a to the gate driving section 180 and common voltages 150b to the display panel 110. Further, the driving voltage generating section 150 provides reference voltages 150c to the reference gray-scale voltage generating section 160.

The reference gray-scale voltage generating section 160 converts the reference voltages (V_{REF}) 150c into the reference gray-scale voltages 160a (VR₁˜VR₁₀) based on the gray-scale reference data 120g that are readout from the gamma storing section 140. Particularly, the reference gray-scale voltage generating section 160 generates reference gray scale voltages 160a including a first reference gray-scale voltage based on a first reference gray-scale data 120g in a first half frame, and a second reference gray-scale voltage based on a second reference gray-scale data 120g in a second half frame.

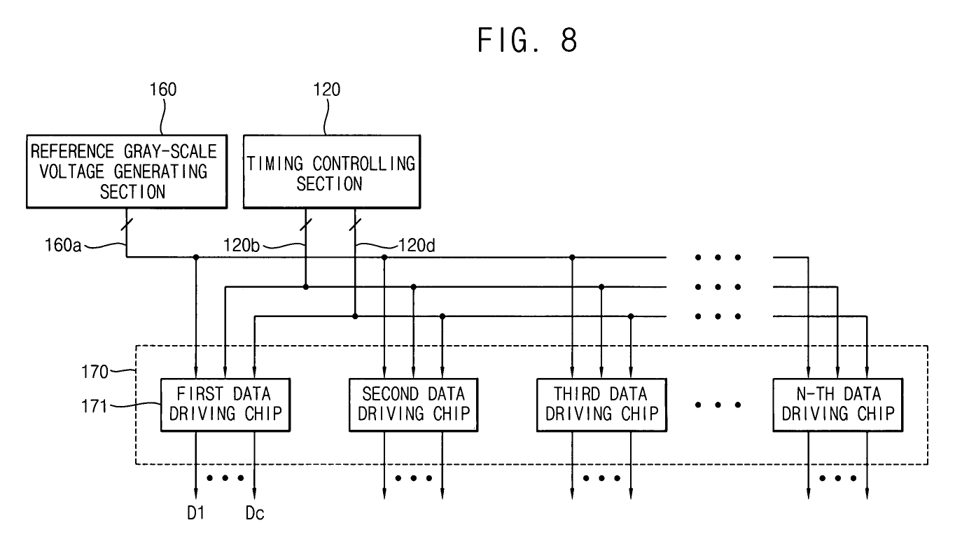

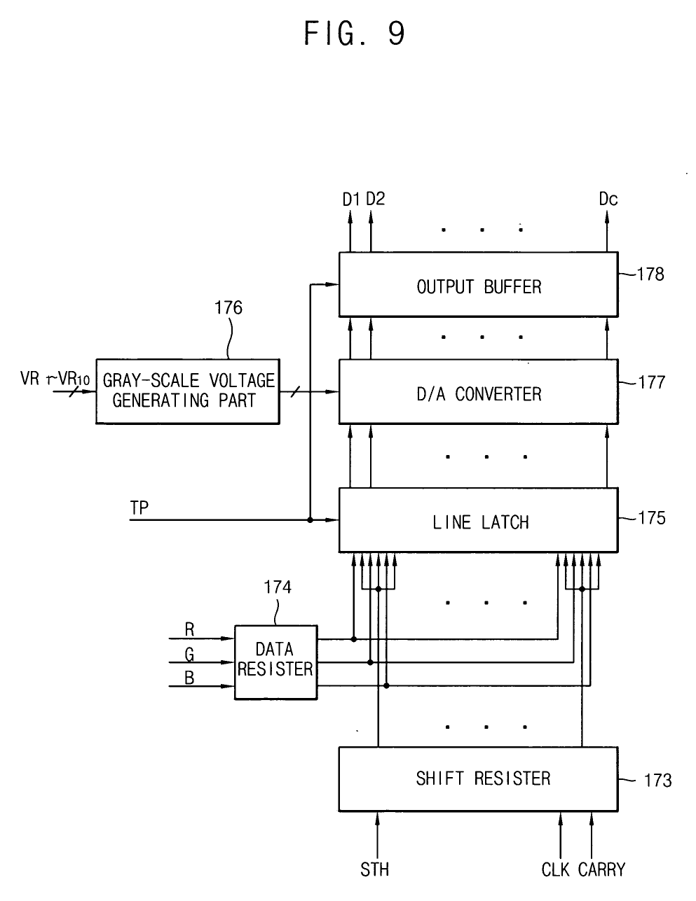

The data driving section 170, as will be further described with respect to FIGS. 8 and 9, converts the inputted preliminary data DATA 120d into first and second gray-scale voltages of an analog-type into the display panel 110 based on the first and second reference gray-scale voltages 160a and outputs the first and second gray-scale voltages to the data lines DL of the display panel 110. Particularly, the data driving section 170 converts the inputted preliminary data DATA 120d into the first gray-scale voltage based on the first reference gray-scale voltage 160a and outputs the first gray-scale voltage to the display panel 110. Further, the data driving section 170 converts the inputted preliminary data DATA 120d into the second gray-scale voltage based on the second reference gray-scale voltage 160a and outputs the second gray-scale voltage to the display panel 110.

The gate driving section 180 generates gate signals based on a third control signal 120c provided from the timing controlling section 120 and the gate voltages 150a provided from the driving voltage generating section 150, and outputs the generated gate signals to the gate lines GL of the display panel 110.

FIG. 6 is a block diagram illustrating an exemplary timing controlling section of the exemplary display apparatus in FIG. 1.

Referring to FIGS. 1 and 6, the timing controlling section 120 includes a controlling part 121 and a control signal generating part 123.

The controlling part 121 records the preliminary data DATA inputted from the external apparatus into the frame storing section 130, and readouts the preliminary data DATA from the frame storing section 130. The controlling part 121 records the preliminary data DATA corresponding to the first driving frequency into the frame storing section 130, and synchronizes the recorded preliminary data DATA with the second driving frequency to output the synchronized preliminary data DATA 120d to the data driving section 170.

The controlling part 121 sequentially outputs the first and second reference gray-scale data 120g respectively corresponding to the first and second gamma curves (γ1) and (γ2) stored in the gamma storing section 140 to the reference gray-scale generating section 160 in one frame. The first and second gamma curves (γ1) and (γ2) may be predetermined or selected by the gamma selection signal S-CONTL inputted into the controlling part 121.

The control signal generating part 123 converts a control signal CONTL corresponding to the first driving frequency into first, second, and third control signals 120a, 120b, and 120c that correspond to the second driving frequency. The first control signal 120a is provided to the driving voltage generating section 150, the second control signal 120b is provided to the data driving section 170, and the third control signal 120c is provided to the gate driving section 180.

Particularly, the control signal CONTL includes a main clock signal (MCLK), a horizontal synchronizing signal (HSYNC), a vertical synchronizing signal (VSYNC), and a data enable signal (DE). The first control signal 120a includes the main clock signal (MCLK). The second control signal 120b includes a horizontal start signal (STH) and a load signal (TP). The third control signal 120c includes a vertical start signal (STV), a scan clock signal (CPV), and an output enable signal (OE).

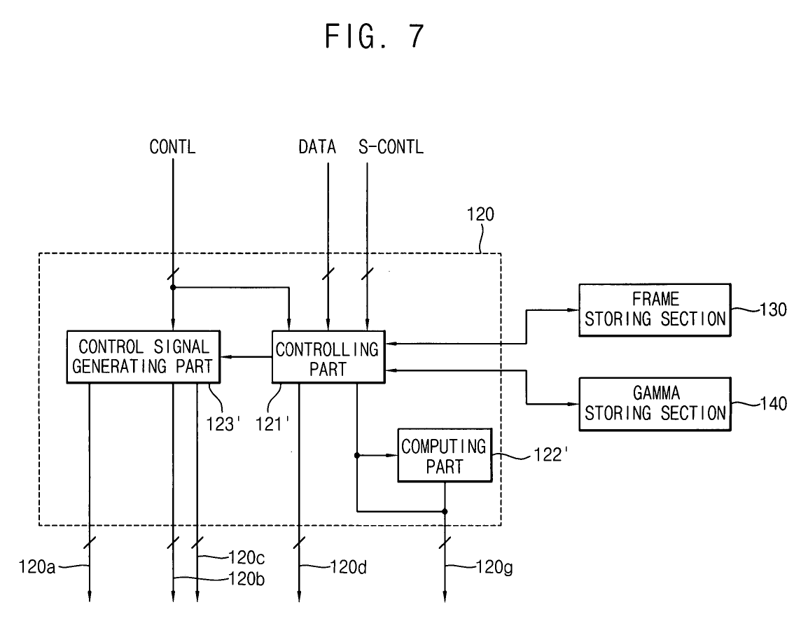

FIG. 7 is a block diagram illustrating another exemplary timing controlling section of an exemplary embodiment of a display apparatus in accordance with the present invention.

Referring to FIG. 7, the timing controlling section 120 includes a controlling part 121′, a computing part 122′, and a control signal generating part 123′.

The controlling part 121′ records the preliminary data DATA inputted from the external apparatus into the frame storing section 130 and readouts the preliminary data DATA from the frame storing section 130. The controlling part 121′ synchronizes the recorded preliminary data 120d with the second driving frequency to readout the synchronized preliminary data 120d to the data driving section 170.

The controlling part 121′ also outputs the first reference gray-scale data 120g corresponding to the first gamma curve (γ1) stored in the gamma storing section 141 to the reference gray-scale voltage generating section 160. Also, the controlling part 121′ provides the first reference gray-scale data 120g to the computing part 122′.

The computing part 122′ previously stores a difference value between a second reference gray-scale data 120g of the second gamma curve (γ2) and the first reference gray-scale data 120g of the first gamma curve (γ1). That is, the difference value is stored in the computing part 122′. Accordingly, the computing part 122′ produces the second reference gray-scale data 120g using the predetermined difference value.

Particularly, the controlling part 121′ outputs the first reference gray-scale data 120g corresponding to the first gamma curve (γ1) in the first half frame. The computing part 122′ outputs the second reference gray-scale data 120g in the second half frame. The gamma storing section 140 stores the first reference gray-scale data corresponding to the first gamma curve (γ1), and the computing part 122′ previously stores the difference value between the first and second reference gray-scale data 120g.

The first and second gamma curves (γ1) and (γ2) may be predetermined or may be selected by the user based on the gamma control signal S-CONTL provided to the controlling part 121′. The first reference gray-scale data 120g corresponding to various first gamma curves (γ1) are stored in the gamma storing section 140. The difference values between the first reference gray-scale data 120g corresponding to the first gamma curves (γ1) and the second reference gray-scale data 120g of the second gamma curves (γ2) that correspond to the first gamma curves (γ1) is previously stored in the computing part 122′. When any one of the first gamma curves (γ1) is selected by the gamma control signal S-CONTL, the computing part 122′ produces the second reference gray-scale data 120g using the predetermined difference value stored therein corresponding to the selected first gamma curve (γ1).

The control signal generating part 123′ generates the first, second, and third control signals 120a, 120b, and 120c that correspond to the second driving frequency based on the control signal CONTL provided to the control signal generating part 123′ corresponding to the first driving frequency. The controlling part 121′ controls the control signal generating part 123′. The first control signal 120a is provided to the driving voltage generating section 150, the second control signal 120b is provided to the data driving section 170, and the third control signal 120c is provided to the gate driving section 180.

FIG. 8 is a block diagram illustrating an exemplary data driving section in FIG. 1. FIG. 9 is a block diagram illustrating an exemplary data driving chip of the exemplary data driving section in FIG. 8.

Referring to FIG. 8, the data driving section 170 includes a plurality of data driving chips 171 to which the reference gray-scale voltages (VR₁˜VR₁₀) 160a, the second control signal 120b, and the preliminary data DATA 120d are inputted.

Referring to FIG. 1 and FIG. 9, the first data driving chip 171 includes a shift resister 173, a data resister 174, a line latch 175, a gray-scale voltage generating part 176, a digital-analog (D/A) converter 177, and an output buffer 178.

The shift resister 173 outputs a latch pulse to the line latch 175 based on the horizontal start signal (STH) provided from the timing controlling section 120. The data resister 174 latches the preliminary data including R, G and B data into the input terminals of the line latch 175. When the latch pulse is inputted from the shift resister 173, the data resister 174 outputs the latched R, G, B data to the line latch 175.

The line latch 175 latches R, G, and B data by lines. When the load signal (TP) is inputted from the timing controlling section 120, the line latch 175 outputs the digital typed R, G, B latched data to the digital-analog (D/A) converter 177. The gray-scale voltage generating part 176 has a fixed distribution resistance. The reference gray-scale voltages 160a provided from the reference gray-scale voltage generating section 160 is converted into the data voltages corresponding to gray-scale levels by the fixed distribution resistance, and the data voltages are outputted from the gray-scale voltage generating part 176 to the digital-analog (D/A) converter 177. Total gray-scale levels may include sixty-four gray-scale levels, two hundred fifty-six gray-scale levels, one thousand twenty four gray-scale levels, etc.

The digital-analog (D/A) converter 177 converts digital typed R, G and B data outputted from the line latch 175 into the gray-scale voltages. The output buffer 178 amplifies the gray-scale voltages from the digital-analog (D/A) converter 177 to a required level and outputs the amplified gray-scale voltages (D₁˜Dc). Particularly, the output buffer 178 outputs the gray-scale voltages (D₁˜Dc) to data lines DL of the display panel 110.

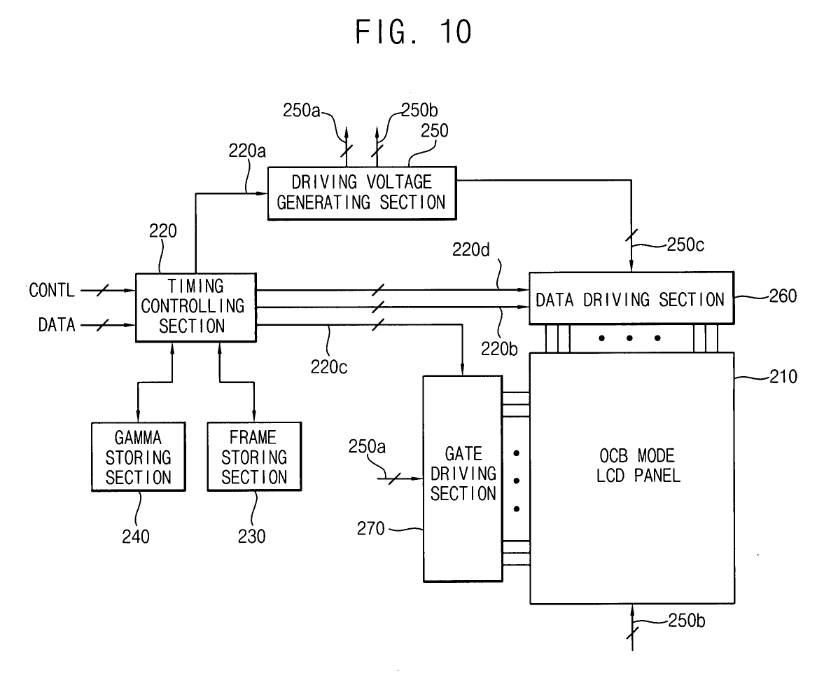

FIG. 10 is a block diagram illustrating another exemplary embodiment of a display apparatus in accordance with the present invention.

Referring to FIG. 10, a display apparatus includes a display panel 210, a timing controlling section 220, a frame storing section 230, a gamma storing section 240, a driving voltage generating section 250, a data driving section 260, and a gate driving section 270.

The display panel 210 includes an array substrate, an upper substrate such as a color filter substrate, and a liquid crystal layer disposed between the upper substrate and the array substrate. The array substrate includes a plurality of data lines DL and a plurality of gate lines GL crossed with the data lines DL to define a plurality of pixels.

The upper substrate includes a color filter to express a color image and a common electrode opposed to pixel electrodes formed within pixels of the array substrate.

The liquid crystal layer is operated at an OCB mode in which liquid crystal is bend-aligned at an initial state. For example, when the display panel operated at a normally white mode, the bend-aligned state may correspond to an initial state of white.

The display panel 210 may be substantially the same as the display panel 110 described with respect to FIGS. 1-3, although variations of the display panel 210 would be within the scope of these embodiments.

The timing controlling section 220 generates a first control signal 220a, a second control signal 220b, and a third control signal 220c based on a control signal CONTL from an external apparatus to generally control the display apparatus. The control signal CONTL corresponds to a first driving frequency. The first to third control signals 220a, 220b, and 220c correspond to a second driving frequency. The control signal CONTL includes a gamma selection signal S-CONTL transmitted from a user interface (not shown).

The first control signal 220a is provided to the driving voltage generating section 250, the second control signal 220b is provided to the data driving section 260, and the third control signal 220c is provided to the gate driving section 270.

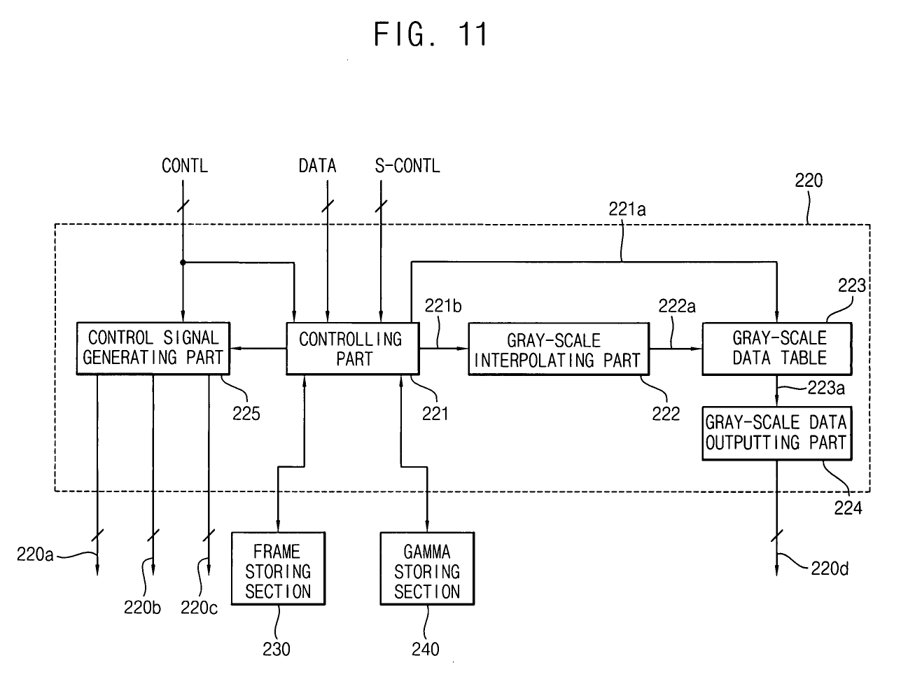

The timing controlling section 220 also outputs a gray-scale data 220d corresponding to a preliminary data DATA inputted from an external apparatus to the data driving section 260. The timing controlling section 220 readouts first and second reference gray-scale data corresponding to first and second gamma curves stored in the gamma storing section 240, respectively. The timing controlling section 220 produces first and second gray-scale data 220d respectively corresponding to the first and second reference gray-scale data that are readout from the timing controlling section 220. The timing controlling section 220 will be described in detail later in the specification by referring to FIG. 11.

The frame storing section 230 stores the preliminary data DATA inputted from the external apparatus by the frame. The timing controlling section 220 stores the preliminary data DATA corresponding to the first driving frequency into the frame storing section 230, and synchronizes the preliminary data DATA stored by the frame with the second driving frequency to produce the first and second gray-scale data 220d.

For example, when the first driving frequency is 60 Hz and the second driving frequency is 120 Hz, an N-th (N denotes a natural number) frame data is converted into first and second sub-frame images by the second driving frequency, and the first and second sub-frame images are displayed to the display panel 210 in one frame.

The gamma storing section 240 includes a read-only memory (ROM), and stores the first and second reference gray-scale data respectively corresponding to the first and second gamma curves (γ1) and (γ2). The reference gray-scale data are digitalized data, and includes several (10˜20) reference gray-scale level data that are sampled among total gray-scale levels and reference gray-scale voltage data corresponding to the reference gray-scale levels.

The first and second gamma curves (γ1) and (γ2) may have various gamma curves, such as, but not limited to, those described above with reference to FIGS. 5A to 5C.

The driving voltage generating section 250 generates driving voltages to drive the display apparatus. Particularly, the driving voltage generating section 250 outputs gate voltages 250a to the gate driving section 270, and common voltages 250b to the display panel 210. The common voltages may be applied, for example, to the common electrode panel of the upper substrate. The driving voltage generating section 250 also outputs several (e.g., six) reference voltages 250c to the data driving section 260.

The data driving section 260 converts the gray-scale data 220d into a gray-scale voltage of an analog type based on the reference voltages 250c to output the analog typed gray-scale voltage to data lines of the display panel 210. Particularly, the data driving section 260 converts the first gray-scale data 220d into a first gray-scale voltage to output to the display panel 210 in a first half frame, and converts the second gray-scale data 220d into a second gray-scale voltage to output to the display panel 210 in a second half frame. While “half” frames are described, the times in which the first and second image frames are displayed need not necessarily be the same.

The gate driving section 270 generates gate signals based on the third control signal 220c provided from the timing controlling section 220 and the gate voltages 250a provided from the driving voltage generating section 250, and outputs the gate signals to gate lines of the display panel 210.

FIG. 11 is a block diagram illustrating an exemplary timing controlling section in FIG. 10.

Referring to FIGS. 10 and 11, the timing controlling section 220 includes a controlling part 221, a gray-scale data interpolating part 222, a gray-scale data table 223, a gray-scale data outputting part 224, and a control signal generating part 225.

The controlling part 221 records the preliminary data DATA inputted from the external apparatus to the frame storing section 130, and readouts the preliminary data DATA from the frame storing section 230. The controlling part 221 synchronizes the recorded data 221a and provides the synchronized data 221a to the gray-scale data table 223.

The controlling part 221 outputs the reference gray-scale data 221b that are read out from the gamma storing section 140 to the gray-scale data interpolating part 222. Particularly, the controlling part 221 sequentially provides first and second reference gray-scale data 221b respectively corresponding to the first and second gamma curves (γ1) and (γ2) stored in the gamma storing section 140 to the gray-scale data interpolating part 222.

The gray-scale data interpolating part 222 produces gray-scale data 222a corresponding to total gray-scale levels by an interpolation process. Particularly, the gray-scale data interpolating part 222 produces the first gray-scale data 222a based on the first reference gray-scale data 221b to provide the first gray-scale data 222a to the gray-scale data table 223 in the first half frame. Further, the gray-scale data interpolating part 222 produces the second gray-scale data 222a based on the second reference gray-scale data 221b to provide the second gray-scale data 222a to the gray-scale data table 223.

The gray-scale data table 223 stores the gray-scale data 222a in a look-up table type. Therefore, the recorded preliminary data 221a provided from the controlling part 221 is converted to the gray-scale data 223a corresponding to the gray-scale levels, and is outputted through the gray-scale data table 223.

Particularly, the first gray-scale data 223a is outputted by applying the first gamma curve (γ1) to the preliminary data 221a of the N-th frame in the first half frame, and the second gray-scale data 223a is outputted by applying the second gamma curve (γ2) to the preliminary data 221a of the N-th frame in the second half frame.

After the gray-scale data outputting part 224 groups the gray-scale data 223a from the gray-scale data table 223 by the channel corresponding to a related data driving chip 261, the gray-scale data outputting part 224 outputs the gray-scale data 220d.

The control signal generating part 225 converts a control signal CONTL inputted to the control signal generating art 225 and corresponding to the first driving frequency into a first control signal 220a, a second control signal 220b, and a third control signal 220c that correspond to the second driving frequency. The first control signal 220a is provided to the driving voltage generating section 250, the second control signal 220b is provided to the data driving section 260, and the third control signal 220c is provided to the gate driving section 270.

Particularly, the control signal CONTL includes a main clock signal (MCLK), a horizontal synchronizing signal (HSYNC), a vertical synchronizing signal (VSYNC), and a data enable signal (DE). The first control signal 220a includes the main clock signal (MCLK). The second control signal 220b includes a horizontal start signal (STH) and a load signal (TP). The third control signal 220c includes a vertical start signal (STV), a scan clock signal (CPV), and an output enable signal (OE).

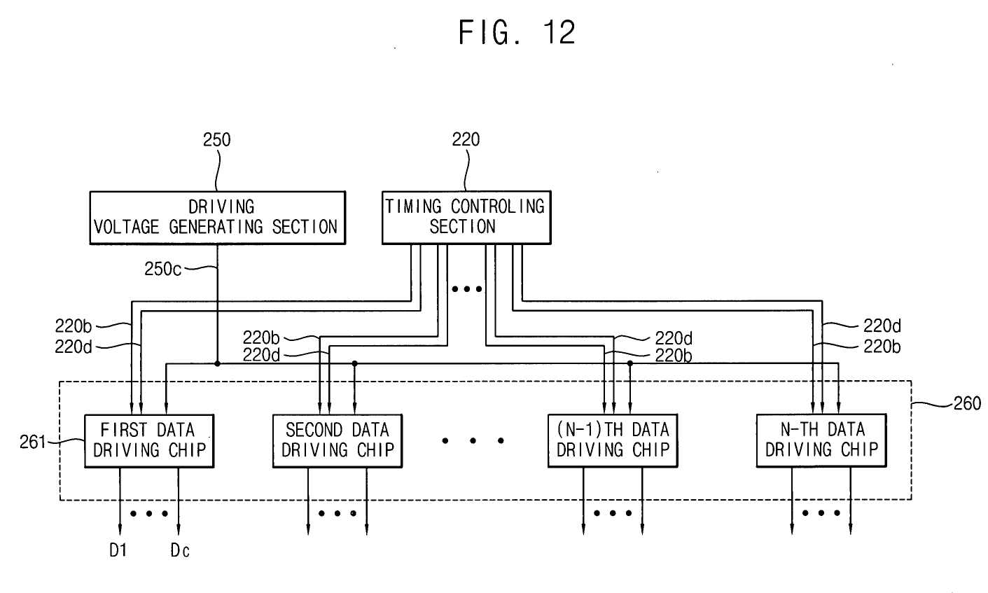

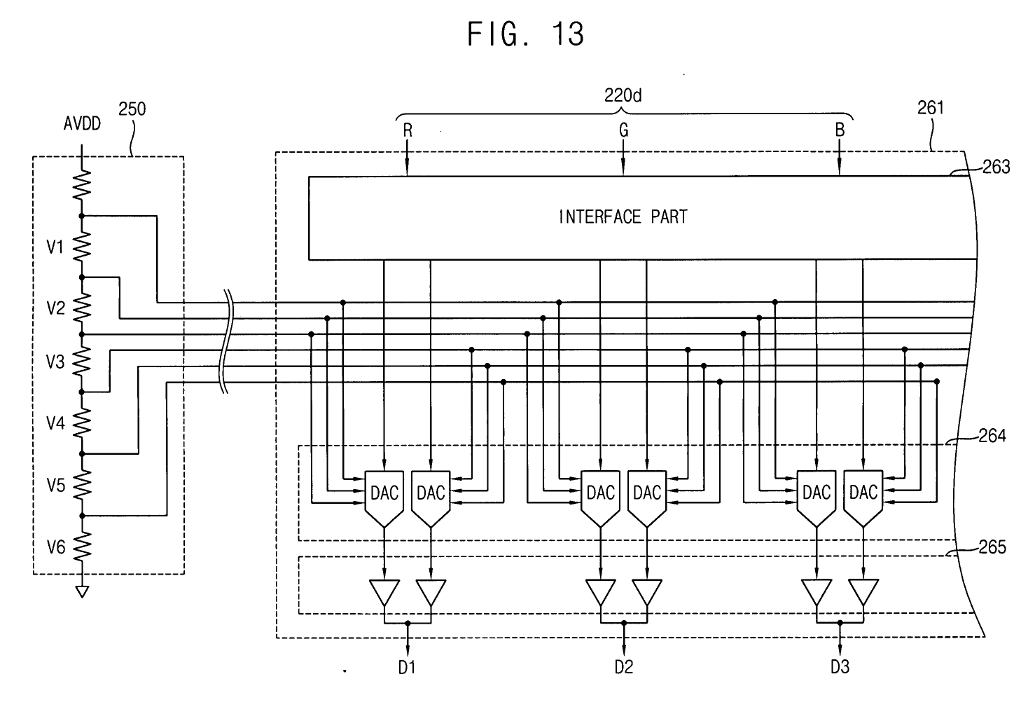

FIG. 12 is a block diagram illustrating an exemplary data driving section of FIG. 10. FIG. 13 is a block diagram illustrating an exemplary first data driving chip of the exemplary data driving section of FIG. 12.

Referring to FIG. 12, the data driving section 260 includes a plurality of data driving chips 261. The data driving chips 261 are electrically connected to the timing controlling section 220 to receive the second control signal 220b and the gray-scale data 220d from the timing controlling section 220.

The data driving chips 261 receive several reference voltages 250c from the driving voltage generating section 250.

Referring to FIGS. 12 and 13, a first data driving chip 261 includes an interface part 263, a digital-analog converter (“DAC”) 264 and an output buffer 265.

The interface part 263 receives the gray-scale data 220d provided from the gray-scale data outputting part 224 of the timing controlling section 220.

The digital-analog converter 264 converts the gray-scale data 220d into the gray-scale voltage of analog type based on the reference voltages (V1˜V6) 250c from the driving voltage generating section 250. The reference voltages (V1, V2, and V3) are used for generating gray-scale voltages having a first polarity with respect to the reference voltages 250c. The reference voltages (V4, V5, and V6) are used for generating gray-scale voltages having a second polarity with respect to the reference voltages 250c.

The output buffer 265 amplifies data voltages D1 to Dc and outputs the amplified voltages to data lines of the display panel 210.

Thus, as shown in FIGS. 10-13, the reference gray-scale generating section 160 of the prior embodiment is incorporated into a timing control section 220.

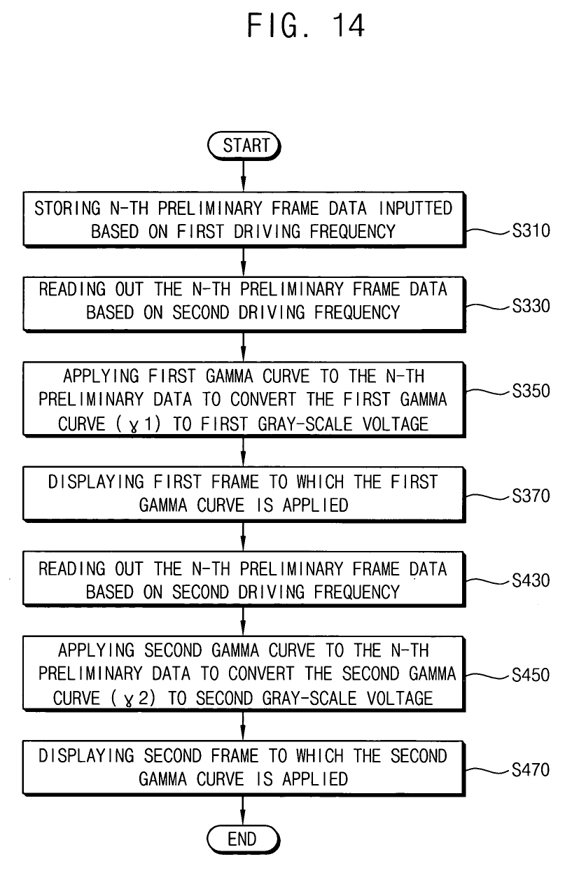

FIG. 14 is a flow chart illustrating an exemplary method of driving an exemplary embodiment of a display apparatus in accordance with the present invention. FIG. 15 is a schematic diagram illustrating an exemplary driving mechanism of an exemplary display apparatus according to the exemplary driving method in FIG. 14. While the exemplary method is described with respect to the embodiment of a display apparatus described with respect to FIG. 1, it should be understood that the exemplary method may also be modified for driving a display apparatus described with respect to FIG. 10.

Referring to FIGS. 1, 14 and 15, preliminary data DATA of N-th frame is recorded in a frame storing section 130 in step S310. As shown in FIG. 15, the preliminary data 510 of N-th frame are inputted from an external apparatus based on a first driving frequency.

Particularly, a timing controlling section 120 readouts the N-th frame data 510, demonstrated by data 120d in FIG. 1, recorded in the frame storing section 130 based on a second driving frequency that is two times the first driving frequency in step S330.

A data driving section 170 applies a first gamma curve (γ1) to the N-th frame data 510 based on a second control signal 120b from the timing controlling section 120 corresponding to the second driving frequency to convert the N-th frame data 510 into a first gray-scale voltage in step S350.

Particularly, the timing controlling section 120 outputs the preliminary data of the N-th frame to the data driving section 170. Also, the timing controlling section 120 provides a first reference gray-scale data 120g corresponding to the first gamma curve (γ1) stored in a gamma storing section 140 to a reference gray-scale voltage generating section 160. The reference gray-scale voltage generating section 160 generates a first reference gray-scale voltage 160a based on the first reference gray-scale data 120g to output the first reference gray-scale voltage 160a to the data driving section 170. The data driving section 170 converts the preliminary data of N-th frame into first gray-scale voltages to which the first gamma curve (γ1) is applied.

The data driving section 170 outputs the first gray-scale voltages to which the first gamma curve (γ1) is applied based on a second control signal 120b to data lines DL of the display panel 110. A gate driving section 180 outputs gate signals to gate lines GL of the display panel 110 based on a third control signal 120c. A first frame image 511, as demonstrated in FIG. 15, to which the first gamma curve (γ1) is applied is displayed on the display panel 110 in step S370.

The timing controlling section 120 readouts again the preliminary data 510 of the N-th frame recorded in the frame storing section 130 based on the second driving frequency in step S430.

The data driving section 170 converts the preliminary data 510 of the N-th frame into the second gray-scale voltage to which a second gamma curve (γ2) is applied based on the second driving frequency in step S450.

Particularly, the timing controlling section 120 outputs the preliminary data 510 of the N-th frame to the data driving section 170. Also, the timing controlling section 120 provides the second reference gray-scale data 120g corresponding to the second gamma curve (γ2) stored in a gamma storing section 140 to a reference gray-scale voltage generating section 160. The reference gray-scale voltage generating section 160 generates a second reference gray-scale voltage 160a based on the second reference gray-scale data 120g to output the second reference gray-scale voltage 160a to the data driving section 170. The data driving section 170 converts the preliminary data 510 of N-th frame into a second gray-scale voltage to which the second gamma curve (γ2) is applied.

The data driving section 170 outputs the second gray-scale voltage to which the second gamma curve (γ2) is applied based on the second control signal 120b to data lines DL of the display panel 110. The gate driving section 180 outputs the gate signals to the gate lines GL of the display panel 110 based on the third control signal 120c. A second frame image 512, as demonstrated in FIG. 15, to which the second gamma curve (γ2) is applied is displayed on the display panel 110 in step S470.

The display apparatus exemplarily described above displays the first frame image in the first half frame, and displays the second frame image having a lower brightness than the first frame image in the second half frame.

While “half” frames are described, however, a time ratio between a first time for the first frame image and a second time for the second frame image may be about 4:6, about 2:8, etc., in that the second frame image may be displayed for longer time than the first frame image. Alternatively, the time ratio between the first time for the first frame image and the second time for the second frame image may be about 6:4, about 8:2, etc., so that the first frame image may be displayed for longer time than the second frame image.

According to the above, since a display apparatus employs a gamma curve with relatively high brightness and a gamma curve with relatively low brightness that have a minimum gray-scale voltage of white level when a bend-aligned state is maintained, the display apparatus may increase a visibility and a brightness of an image at an OCB mode.

Further, since the display apparatus employs the gamma curve with relatively high brightness and the gamma curve with relatively low brightness of which average curve corresponds to a reference gamma curve, the display apparatus may improve the visibility and the brightness of the image.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A display apparatus comprising:
a first substrate including a first electrode;
a second substrate opposing the first substrate, the second substrate including a second electrode;
a liquid crystal layer disposed between the first and second substrates, the liquid crystal layer comprising liquid crystal molecules that are horizontally oriented in one direction, the liquid crystal molecules being aligned symmetrically bent with respect to an imaginary center plane between the first and second substrates when an electric field is generated between the first and second electrodes; and
a driving system outputting a first gray-scale voltage and a second gray-scale voltage into the at least one of the first and the second substrate after the driving system receives preliminary data from an exterior source and converts the preliminary data into the first and the second gray-scale voltages by applying a first gamma curve and a second gamma curve, the first and the second gray-scale voltages depending on the first and second gamma curves, respectively.

2. The display apparatus of claim 1, wherein the second gray scale voltage corresponds to black data in a lower level than a specific value, and gray data in a higher level than the specific value.

3. The display apparatus of claim 1, wherein a white gray-scale voltage of the second gamma curve is no smaller than a minimum voltage to maintain a bend-aligned state of the liquid crystal layer.

4. The display apparatus of claim 3, wherein a white gray-scale voltage of the second gamma curve is a minimum voltage to maintain a bend-aligned state of the liquid crystal layer when the first gamma curve is a standard gamma curve.

5. The display apparatus of claim 1, wherein a white gray-scale voltage of the first gamma curve is smaller than a minimum voltage to maintain a bend-aligned state of the liquid crystal layer.

6. The display apparatus of claim 1, wherein a sum of transmittances of the first and second gamma curves corresponds to a transmittance of a standard gamma curve.

7. The display apparatus of claim 1, wherein the driving system comprises:
a first storing section storing the preliminary data based on a first driving frequency;
a second storing section storing first and second reference gray-scale data respectively corresponding to the first and second gamma curves; and
a timing controlling section reading out the preliminary data stored in the first storing section based on a second driving frequency, the second driving frequency being a multiple of the first driving frequency, and reading out the first and second reference gray-scale data stored in the second storing section based on the second driving frequency.

8. The display apparatus of claim 7, further comprising:
a reference gray-scale voltage generating section generating first and second reference gray-scale voltages respectively based on the first and second reference gray-scale data; and
a data driving section converting the preliminary data into first and second analog gray-scale voltages respectively using the first and second reference gray-scale voltages to output the first and second gray-scale voltages into the at least one of the first and the second substrate.

9. The display apparatus of claim 8, further comprising a driving voltage generating section providing reference voltages to the reference gray-scale voltage generating section.

10. The display apparatus of claim 1, wherein the driving system comprises:
a first storing section storing the preliminary data based on a first driving frequency;
a second storing section storing first and second reference gray-scale data respectively corresponding to the first and second gamma curves; and
a timing controlling section reading out the preliminary data stored in the first storing section based on a second driving frequency, the second driving frequency being a multiple of the first driving frequency, and applying the first and second gamma curves to the preliminary data to generate first and second gray-scale data.

11. The display apparatus of claim 10, wherein the timing controlling section further comprises:
an interpolating part generating the first and second gray-scale data corresponding to entire gray-scale levels based on first and second reference gray-scale data; and
a table part generating first and second gray-scale data corresponding to each of the preliminary data.

12. The display apparatus of claim 10, further comprising a data driving section outputting first and second gray-scale voltages to the at least one of the first and the second substrate based on the first and second gray-scale data, respectively.

13. The display apparatus of claim 10, wherein the first and second gray-scale data is output from the timing controlling section directly to the data driving section.

14. The display apparatus of claim 1, wherein the driving system outputs the first gray-scale voltage for a first time period of a frame image, and subsequently outputs the second gray-scale voltage for a second time period of the frame image.

15. The display apparatus of claim 14, wherein the frame image during the first time period is brighter than the frame image during the second time period.

16. The display apparatus of claim 1, wherein the first gamma curve has a higher brightness than the second gamma curve.

17. A driving apparatus for a display apparatus comprising a liquid crystal layer operated at an optically compensated birefringence mode to display an image, the driving apparatus comprising:
a timing controlling section receiving preliminary data based on a first driving frequency to output the preliminary data based on a second driving frequency;
a storing section storing first and second reference gray-scale data respectively corresponding to first and second gamma curves, the first gamma curve having a white gray-scale voltage smaller than a minimum voltage to maintain a bend-aligned state of the liquid crystal layer and the second gamma curve having a white gray-scale voltage larger than the minimum voltage;
a reference gray-scale voltage generating section generating first and second reference gray-scale voltages based on the first and second reference gray-scale data; and
a data driving section converting the preliminary data into first and second gray-scale voltages respectively based on the first and second reference gray-scale voltages to output the first and second gray-scale voltages to the at least one of a first and a second substrate.

18. The driving apparatus of claim 17, wherein a sum of transmittances of the first and second gamma curves corresponds to a transmittance of a standard gamma curve.

19. The driving apparatus of claim 17, wherein the data driving section outputs the first and second gray-scale voltages to the at least one of the first and the second substrate in one frame.

20. The driving apparatus of claim 19, wherein the first gray-scale voltage is output prior to the second gray-scale voltage.

21. A driving apparatus for a display apparatus comprising a liquid crystal layer operated at an optically compensated birefringence mode to display an image, the driving apparatus comprising:
a storing section storing first and second reference gray-scale data respectively corresponding to first and second gamma curves, the first gamma curve having a white gray-scale voltage smaller than a minimum voltage to maintain a bend-aligned state of the liquid crystal layer and the second gamma curve having a white gray-scale voltage larger than the minimum voltage;
a timing controlling section receiving preliminary data and respectively applying the first and second gamma curves to the preliminary data to convert the preliminary data into first and second gray-scale data and outputting the first and second gray-scale data; and
a data driving section converting the first and second gray-scale data into first and second analog gray-scale voltages to output the first and second analog gray-scale voltages to at least one of a first and a second substrate.

22. A driving apparatus for a display apparatus comprising a liquid crystal layer operated at an optically compensated birefringence mode to display an image, the driving apparatus comprising:
a storing section storing a first reference gray-scale data corresponding to a first gamma curve having a white gray-scale voltage smaller than a minimum voltage to maintain a bend-aligned state of the liquid crystal layer;
a timing controlling section receiving a preliminary data based on a first driving frequency to output the preliminary data based on a second driving frequency, and reading out the first reference gray-scale data in the storing section;
a computing section generating a second reference gray-scale data corresponding to a second gamma curve and based on the first reference gray-scale data;
a reference gray-scale voltage generating section generating first and second reference gray-scale voltages based on the first and second reference gray-scale data; and
a data driving section converting the preliminary data into first and second gray-scale voltages respectively based on the first and second reference gray-scale voltages, to output the first and second gray-scale voltages to at least one of a first and a second substrate.

23. The driving apparatus of claim 22, wherein the computing section is within the timing control section.

24. The driving apparatus of claim 22, wherein the computing section comprises a previously stored predetermined difference value between the first and second reference gray-scale data, and generates the second reference gray-scale data using an inputted first reference gray-scale data and the predetermined difference value.

25. The driving apparatus of claim 22, wherein the second gamma curve has a white gray-scale voltage larger than the minimum voltage to maintain a bend-aligned state of the liquid crystal layer.

26. A method of driving a display apparatus comprising a liquid crystal layer operated at an optically compensated birefringence mode to display an image, the method comprising:
applying a first gamma curve to preliminary frame data in a first time period of the frame to generate a first gray-scale voltage; and
applying a second gamma curve having a lower brightness than the first gamma curve to the preliminary frame data in a second time period of the frame to generate a second gray-scale voltage.

27. The method of claim 26, wherein the first time period occurs prior to the second time period.

28. The method of claim 26, further comprising outputting the first gray-scale voltage and the second gray-scale voltage to data lines of the display apparatus.

29. The method of claim 26, wherein the first gamma curve has a white gray-scale voltage smaller than a minimum voltage to maintain a bend-aligned state of the liquid crystal layer.

30. The method of claim 26, wherein the second gamma curve has a white gray-scale voltage larger than a minimum voltage to maintain a bend-aligned state of the liquid crystal layer.

31. The method of claim 30, wherein the first gamma curve has a white gray-scale voltage smaller than the minimum voltage.

32. The method of claim 26, wherein the first time period is substantially identical to the second time period.

33. The method of claim 26, wherein the first time period is substantially different from the second time period.
